(19) United States
(12) Patent Application Publication
(10) Pub. No.: US 2014/0011415 A1
(43) Pub. Date: Jan. 9, 2014

(54) THERMOPLASTICALLY DEFORMABLE COMPOSITE MATERIAL

(71) Applicant: Andreas Keilbach, Laufenburg (DE)

(72) Inventor: Andreas Keilbach, Laufenburg (DE)

(73) Assignee: QUADRANT PLASTIC COMPOSITES AG, Lenzburg (CH)

(21) Appl. No.: 14/005,619

(22) PCT Filed: Mar. 19, 2012
(86) PCT No.: PCT/EP2012/054834

§ 371 Date: Sep. 17, 2013

(30) Foreign Application Priority Data
Mar. 18, 2011 (EP) 11158864.6

(51) Int. Cl. B32B 5/26

(52) U.S. Cl. CPC B32B 5/26
USPC 442/189; 442/268; 442/278; 442/272; 28/107

(57) ABSTRACT

Thermoplastically deformable composite materials have a core layer with a glass fiber woven ply connected on both sides thereof to a fiber nonwoven ply of polypropylene fibers and glass fibers. The core layer is connected with at least one cover layer which comprises polypropylene fibers and polyethylene terephthalate fibers. The composite materials are produced by needling the individual layers and heating to melt the polypropylene fibers. The composite materials are useful for preparing automotive parts.

### CROSS-REFERENCE TO RELATED APPLICATIONS

This application is the U.S. National Phase of PCT/EP2012/054834 filed Mar. 19, 2012, which claims priority to European Patent Application No. 11158864.6 filed Mar. 18, 2011, the disclosures of which are incorporated in their entirety by reference herein.

### BACKGROUND OF THE INVENTION

1. Technical Field

The invention relates to a thermoplastically deformable composite material comprising a core layer with a glass fiber woven ply, connected on both sides thereof to a fiber nonwoven ply, and further comprising at least one cover layer, and it further relates to a process for producing such a composite material and also to its use.

2. Description of the Related Art

In WO 2006/111037 there is described a composite material that is preferably made of a glass fiber woven ply B which is needled on both sides thereof to a fiber nonwoven ply A. This composite material can be used, for example, in the automotive field.

WO 2006/048304 describes a lining part for automobiles which comprises a porous core layer and cover layers. The core layer consists either of a porous fiber nonwoven made of glass fibers and polypropylene fibers or of a plastic foam, and the cover layers consist either of a polypropylene fiber nonwoven reinforced with glass fibers or of a foil made of aluminum or a high-melting polymer. The lining part may further comprise a thin cover made of a polyethylene terephthalate nonwoven.

### SUMMARY OF THE INVENTION

It was an object of the invention to provide an improved composite material that is particularly suitable for engine encapsulations and that has a high acoustic absorption, an adequate protection against stone chips, a high tear propagation strength, a good water and oil resistance and that can be fitted with flame protection means.

These and other objects are achieved by means of the composite material of the present invention, a thermoplastically deformable composite material which comprises a core layer with a glass fiber woven ply B that is connected on both sides thereof to a fiber nonwoven ply A comprising polypropylene fibers (PPF) and glass fibers (GF), and characterized in that the core layer is connected to at least one cover layer D formed as a nonwoven comprising polyethylene terephthalate fibers (PETF) and PPF. In a specific embodiment, there is inserted between the core layer and the cover layer an intermediate layer C formed as a nonwoven which comprises GF and PPF.

### DETAILED DESCRIPTION OF THE PREFERRED EMBODIMENTS

The glass fiber woven ply B preferably has an areal weight of 200 to 1000 g/m², particularly of 400 to 800 g/m². The fibers are preferably present as fiber bundles with a titer of 30 to 3000 tex. The woven may have a longitudinal/transverse balance of 4/1, with linen weave. A 1/1 balance is also possible. The glass fiber woven provides the composite material with a high shock resistance and tear propagation strength.

The fiber nonwoven plies A preferably consist of 30 to 60 wt.-% GF and 70 to 40 wt.-% PPF, particularly of 40 to 55 wt.-% GF and 60 to 45 wt.-% PPF. Their areal weight is preferably 200 to 2000 g/m², particularly 500 to 1000 g/m². The fiber nonwoven plies A are preferably produced according to the carding or airlay process, whereby an endless ribbon with an air voids content of preferably 40 to 80 vol.-%, particularly of 50 to 70 vol.-% is obtained.

The cover layer D preferably consists of 20 to 60 wt.-% PETF and 80 to 40 wt.-% PPF, particularly of 30 to 50 wt.-% PETF and 70 to 50 wt.-% PPF. Its areal weight is preferably 20 to 500 g/m², particularly 30 to 300 g/m². The composite material preferably comprises cover layers D on both sides thereof, but it is also possible to provide only one cover layer D and to arrange a polypropylene foil on the other side. This foil is fused to the core layer in such manner that it adheres well and simultaneously acts as a closed sealing layer.

The cover layer D preferably has an air voids content of 0 to 20 vol.-%, particularly of 1 to 15 vol.-%. It provides the composite material with high acoustic absorption, good stone chip protection and sufficient water and oil resistance.

The optional intermediate layer C that is disposed between the core layer and the cover layers in the alternative embodiment preferably contains 5 to 40 wt.-% GF and 95 to 60 wt.-% PPF, particularly 10 to 30 wt.-% GF and 90 to 70 wt.-% PPF. The air voids content is preferably 5 to 50 vol.-%, particularly 10 to 30 vol.-%. The optional intermediate layer C provides the composite material with good rigidity and improved acoustic absorption.

The individual plies or layers are connected to each other thermally and preferably also by needling. The needling causes a partial orientation of the glass fibers in a z direction whereby during the later processing of the composite material the restoring forces of the fibers can be effective after press molding, when reheating to produce the finished part. In this preferred embodiment one initially connects the nonwovens D and A and the woven B, and also the nonwovens D and A, and subsequently the two structures thus obtained are needled together. The needled complex is then briefly heated, e.g. for 30 to 360 sec, to temperatures between 180 and 210° C., e.g. in a continuous air oven or by means of IR irradiation, thereby causing the polypropylene to melt. The melt thus soaks the glass fibers and thereby links them together. In the alternative embodiment one initially connects the nonwovens D, C and A, and also the nonwovens D and C as well as the nonwovens A plus the woven B, and subsequently the three structures thus obtained are needled together. The needled complex is then heated for melting the polypropylene as described above.

The porous composite material is then pressed in a laminator at low pressure, preferably for 5 to 60 sec at 0.05 to 1 bar, for example in a double band press or in a laminating device. Due to the restoring forces of the z oriented glass fibers the air voids are largely maintained. The individual actions and steps during heating and pressing are described in detail in EP-B 1 868 796. During this treatment in the laminator the molten polypropylene matrix has sufficient time to effectively link with the reinforcing fibers and the cover plies, thereby causing a regular distribution of the air voids and the fibers in the composite material.

If a polypropylene foil shall be applied as an alternative to one of the cover layers D, such polypropylene foil is inserted after the oven treatment into, for example, a double band press, where it is melted to the still hot nonwoven core at about 180° C., i.e. above the melting point, or it is melted to the outer side by means of a tempered double band press at about 150° C., i.e. below the melting point.

The sheet-like composite materials of the present invention can be stored as precut parts. They are particularly useful for producing automotive outer parts, especially for engine encapsulations and as underbody protection. For this purpose, the materials are thermoplastically formed to obtain finished parts, for example in two-part molds or by means of deep-drawing. After having been molded under pressure, the molded part re-expands at the high temperatures applied due to the restoring force of the fiber reinforcement, so that the air voids contained therein maintain their acoustic efficacy also in the finished part.

In the following table the individual layers are listed along with their structure, the composition of the nonwovens, their areal weight and their air voids content. For a better understanding those layers that could be arranged on two sides are numbered consecutively, wherein, for example, the index 1 can be understood as referring to “above” and the index 2 can be understood as referring to “below” the core layer B. The layers are needled together.

TABLE
Structure of the layers

| | | Wt.-% | | Air voids |
|---|---|---|---|---|
| Layer | Layer structure | GF or PETF | Areal weight | content |
| D1 | PP/PET | 30-50% PET | 30-300 g/m² | 0-20% |
| | nonwoven | | | |
| C1* | PP/GF | 10-30% GF | 200-400 g/m² | 10-30% |
| | nonwoven | | | |
| A1 | PP/GF | 40-55% GF | 500-1000 g/m² | 50-70% |
| | nonwoven | | | |
| B | GF woven | 100% GF | 400-800 g/m² | 0 |
| A2 | PP/GF | 40-55% GF | 500-1000 g/m² | 50-70% |
| | nonwoven | | | |
| C2* | PP/GF | 10-30% GF | 200-400 g/m² | 10-30% |
| | nonwoven | | | |
| D2* | PP/PET | 30-50% PET | 30-300 g/m² | 0-20% |
| | nonwoven | | | |

*The layers C1, C2 and D2 are optional.

### Stone Chip Protection

A puncture test according to the norm ISO 6603-2 was performed at room temperature. For this purpose, test pieces with a thickness of 2.0 mm, 4.0 mm and 6.0 mm were used. For statistical confirmation 9 test pieces each were tested. The test pieces according to the present invention had the following structure according to the above mentioned notation (D1-A1-B-A2-D2):

| | | | | Air voids |
|---|---|---|---|---|
| Layer | Layer structure | Wt.-% | Areal weight | content |
| D1 | PP/PET | 30% PET | 200 g/m² | 10% |
| | nonwoven | | | |
| A1 | PP/GF | 40% GF | 600 g/m² | 60% |
| | nonwoven | | | |
| B | GF woven | 100% GF | 700 g/m² | 0 |
| A2 | PP/GF | 40% GF | 600 g/m² | 60% |
| | nonwoven | | | |
| D2 | PP/PET | 30% PET | 100 g/m² | 10% |
| | nonwoven | | | |

The results of the puncture test can be summarized as follows *:

| Thickness | | Energy [J] | |
|---|---|---|---|
| [mm] | Maximum force [N] | at maximum force | Total energy [J] |
| 2 | 1973 (116) | 9.55 (3.43) | 22.84 (1.24) |
| 4 | 1874 (105) | 9.59 (3.71) | 23.08 (2.09) |
| 6 | 2046 (226) | 9.89 (2.56) | 24.28 (3.53) |

*Standard deviations are shown in parentheses

The above mentioned puncture values, both in the fully consolidated state (2.0 mm) and in a range of a thickness values from 4.0 mm to 6.0 mm, are more than 40% higher than those of comparable test pieces without reinforcing layer B.

1-11. (canceled)

12. A thermoplastically deformable composite material, comprising
a core layer with a glass fiber woven ply B, connected on both sides thereof to a fiber nonwoven ply A which comprises polypropylene fibers (PPF) and glass fibers (GF), wherein the core layer is connected with at least one nonwoven cover layer D which comprises polyethylene terephthalate fibers (PETF) and PPF.

13. The composite material of claim 12, further comprising an intermediate layer C which comprises GF and PPF between the core layer and the cover layer.

14. The composite material of claim 12, wherein the individual layers or plies have the following composition:
A: 30 to 60 wt.-% GF and 70 to 40 wt.-% PPF,
B: 100 wt.-% glass fiber woven, and
D: 20 to 60 wt.-% PETF and 80 to 40 wt.-% PPF.

15. The composite material of claim 13, wherein the individual layers or plies have the following composition:
A: 30 to 60 wt.-% GF and 70 to 40 wt.-% PPF,
B: 100 wt.-% glass fiber woven,
C: 5 to 40 wt.-% GF and 95 to 60 wt.-% PPF, and
D: 20 to 60 wt.-% PETF and 80 to 40 wt.-% PPF.

16. The composite material of claim 12, wherein the individual plies or layers have the following areal weights:
A: 200 to 2000 g/m² ,
B: 200 to 1000 g/m², and
D: 20 to 500 g/m².

17. The composite material of claim 13, wherein the individual plies or layers have the following areal weights:
A: 200 to 2000 g/m² ,
B: 200 to 1000 g/m²,
C: 100 to 500 g/m², and
D: 20 to 500 g/m².

18. The composite material of claim 14, wherein the individual plies or layers have the following areal weights:
A: 200 to 2000 g/m² ,
B: 200 to 1000 g/m², and
D: 20 to 500 g/m².

19. The composite material of claim 15, wherein the individual plies or layers have the following areal weights:
A: 200 to 2000 g/m² ,
B: 200 to 1000 g/m²,
C: 100 to 500 g/m², and
D: 20 to 500 g/m².

20. The composite material of claim 12, wherein the individual layers or plies have the following voids contents:
A: 40 to 80 vol.-%, and
D: 0 to 20 vol.-%.

21. The composite material of claim 13, wherein the individual layers or plies have the following voids contents:
A: 40 to 80 vol.-%,
C: 5 to 50 vol.-%, and
D: 0 to 20 vol.-%.

22. The composite material of claim 17, wherein the individual layers or plies have the following voids contents:
A: 40 to 80 vol.-%,
C: 5 to 50 vol.-%, and
D: 0 to 20 vol.-%.

23. The composite material of claim 12, wherein the layers are thermally fused to each other.

24. The composite material of claim 23, wherein the layers are furthermore needled to each other.

25. The composite material of claim 12, wherein the composite material comprises a cover layer D on only one side thereof and on the other side thereof there is a layer comprising a polypropylene foil.

26. A method for producing a composite material of claim 12, comprising initially connecting nonwoven D, A, and woven B, to form a first structure and connecting nonwoven D and nonwoven A to form a second structure, subsequently needling together the two structures thus obtained to form a needled complex, and heating the needled complex to a temperature between 180 and 210° C., thereby causing polypropylene to melt and link the fibers in the structures together.

27. A method for producing a composite material of claim 13, comprising initially connecting nonwovens D, C and A to form a first structure, connecting nonwovens D and C to form a second structure, and connecting nonwoven A and woven B to form a third structure, subsequently needling the three structures thus obtained together to form a needled complex, and heating the needled complex to a temperature between 180 and 210° C. thereby causing polypropylene to melt and link the fibers in the structures together.

28. An automotive engine encapsulation part comprising a thermoformed composite material of claim 12.

29. An automotive engine encapsulation part comprising a thermoformed composite material of claim 13.

30. An automotive underbody protection part, comprising a thermoformed composite material of claim 12.

31. An automotive underbody protection part, comprising a thermoformed composite material of claim 13.
